(19) United States
(12) Patent Application Publication
(10) Pub. No.: US 2023/0001248 A1
(43) Pub. Date: Jan. 5, 2023

(54) ADJUSTABLE DEFLECTOR TO FLOOR SPRINKLER ADAPTER FOR SLOPED CEILING

(71) Applicant: Tyco Fire Products LP, Lansdale, PA (US)

(72) Inventor: Jeremy Cogswell, Johnston, RI (US)

(73) Assignee: Tyco Fire Products LP, Lansdale, PA (US)

(21) Appl. No.: 17/778,947

(22) PCT Filed: Jan. 28, 2021
(86) PCT No.: PCT/IB2021/050687

§ 371 Date: May 23, 2022

Related U.S. Application Data
(60) Provisional application No. 62/968,620, filed on Jan. 31, 2020.

(51) Int. Cl. A62C 37/09; A62C 35/68

(52) U.S. Cl. CPC A62C 37/09; A62C 35/68

(57) ABSTRACT

A fire suppression system includes a pipe system in communication with a fluid supply, a connector, at least one adapter pipe, and a sprinkler. The pipe system includes a first pipe and a second pipe that define a fluid supply axis oriented at an angle relative to a floor below the first pipe and the second pipe. The connector includes a connector inlet engaged with the first pipe, a connector outlet engaged with the second pipe, and an adapter outlet in communication with the connector inlet and the connector outlet. The at least one adapter pipe is engaged with the adapter outlet of the connector. The sprinkler is coupled with the at least one adapter pipe such that a spray pattern of fluid outputted by the sprinkler is oriented to correspond with a target orientation of the spray pattern.

### CROSS-REFERENCE TO RELATED APPLICATIONS

The present application claims the benefit of and priority to U.S. Provisional Application No. 62/968,620, filed Jan. 31, 2020, the disclosure of which is incorporated herein by reference in its entirety.

### BACKGROUND

Sprinkler systems can be provided in buildings to address fire conditions. Sprinkler systems can include fire protection sprinklers that connect with piping systems to receive fluid to address the fire conditions.

### SUMMARY

At least one aspect relates to a fire suppression system. The fire suppression system includes a pipe system in communication with a fluid supply, a connector, at least one adapter pipe, and a sprinkler. The pipe system includes a first pipe and a second pipe that define a fluid supply axis oriented at an angle relative to a floor below the first pipe and the second pipe. The connector includes a connector inlet engaged with the first pipe, a connector outlet engaged with the second pipe, and an adapter outlet in communication with the connector inlet and the connector outlet. The at least one adapter pipe is engaged with the adapter outlet of the connector. The sprinkler is coupled with the at least one adapter pipe such that a spray pattern of fluid outputted by the sprinkler is oriented to correspond with a target orientation of the spray pattern.

At least one aspect relates to an adapter assembly for a fire suppression system. The adapter assembly includes a connector that includes a connector inlet that engages with a first pipe, a connector outlet that engages with a second pipe, and an adapter outlet in communication with the connector inlet and the connector outlet. The connector inlet and the connector outlet define a fluid supply axis. The at least one adapter pipe engages with the connector outlet and defines a fluid release axis. The fluid release axis is at least one of acutely and obtusely angled relative to the fluid supply axis. The sprinkler is coupled with the at least one adapter pipe such that a spray pattern of fluid outputted by the sprinkler is oriented to correspond with a target orientation of the spray pattern.

At least one aspect of the present disclosure relates to a method. The method can include coupling at least one connector to a first pipe and a second pipe of a network of piping coupled with a ceiling of a building, the first pipe and second pipe defining a fluid supply axis. The method can include attaching an adapter pipe to the at least one connector, the adapter pipe defines a fluid release axis. The method can include attaching a sprinkler to the adapter pipe along the fluid release axis. The method can include angling the adapter pipe relative to the connector such that the fluid release axis is at a target angle relative to a floor of the building and locking the adapter pipe such that the sprinkler is maintained in an orientation corresponding to a target orientation of a spray pattern of fluid outputted by the sprinkler.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 is a schematic diagram of a fire protection system associated with a sloped ceiling and fittings for connecting sprinklers with piping of the fire protection system.

FIG. 2 is a schematic diagram of an adapter assembly for use with a sloped ceiling.

FIG. 3 is a schematic diagram of an adapter assembly.

FIG. 4 is a schematic diagram of an adapter assembly for use with a sloped ceiling.

FIG. 5 is a schematic diagram of an adapter assembly.

FIG. 6 is a schematic diagram of a locking mechanism.

FIG. 7 is a schematic diagram of a locking mechanism.

FIG. 8 is a flowchart depicting a method of installing an adapter assembly.

### DETAILED DESCRIPTION

The present disclosure relates generally to the field of fire protection systems, and more particularly to systems and methods of angled fittings for sloped ceilings. Following below are more detailed descriptions of various concepts related to, and implementations of angled fittings for sloped ceilings. Angled fittings can be used where piping may be angled relative to a floor, such as due to being connected with a sloped ceiling. The various concepts introduced above and discussed in greater detail below can be implemented in any of numerous ways, including in new installations as well as retrofits of fire protection systems and sprinklers.

Fire suppression systems are utilized in buildings (e.g., residential, commercial, etc.) to suppress a fire in the event a fire occurs. The fire suppression system includes piping which directs fire suppressant (e.g., water, agent, etc.) from a source of fire suppressant to sprinklers. The sprinklers release the fire suppressant within a room to suppress the fire.

In some situations, piping of a fire protection system can be at an angle relative to ground (e.g., a sloped ceiling, etc.). This may result in sprinklers connected with the piping, including the deflectors thereof, also being angled relative to ground, so that a spray pattern from the sprinkler (which may be specifically tailored to the geometry of the building or other environment in which the sprinkler is installed based on the configuration of the deflector) does not have desired characteristics in the space that the sprinkler is intended to address a fire. This can reduce the effectiveness of the fire protection and potentially not suppress a fire adequately. Installing the fire protection system may depend on certification from authorities such as FM Global or NFPA, which may establish standards regarding angles between the deflector and the floor.

An adapter assembly structured to enable changing of the angle of the sprinkler relative to the piping may be incorporated within the fire suppression system. The adapter assembly may facilitate repositioning of the sprinkler to a target orientation (e.g., to be parallel to the ground; so that an axis through the sprinkler is perpendicular to the ground), which redirects the spray pattern to a target orientation for the spray pattern (e.g., so that a plane defined by the spray pattern is parallel to the ground) to increase the effectiveness of fire protection of the sprinklers. The adapter assembly can be installed in a preexisting fire suppression system (e.g., a retrofit installation, etc.) or can be installed during installation of the fire suppression system (e.g., a new installation, etc.).

For example, a fire suppression system may be installed in a building which has sloped ceilings relative to the ground and the piping is installed to be parallel to the ceiling. Therefore, the piping is angled relative to the ground and any sprinklers installed directly into the piping may not have a spray pattern having a desired orientation relative to the ground, such as parallel to the ground, reducing the effectiveness of the sprinklers. An adapter assembly can be coupled with the pipe and the sprinkler to rotate the sprinkler relative to the pipe at a specific angle. The specific angle can be an angle to enable the sprinkler to generate a spray pattern having a target orientation or angle relative to the ground. The adapter assembly can be locked in place once at the specific angle to prevent the angle of the sprinkler relative to the piping from changing during activation of the fire suppression system.

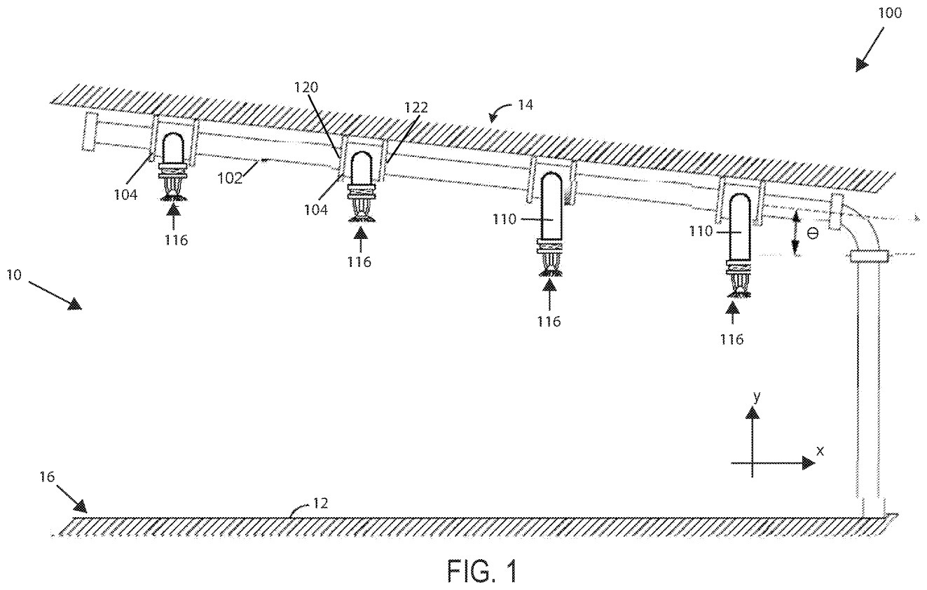

Referring to FIG. 1, a fire suppression system 100 is shown. The fire suppression system 100 can be used in a building 10 (e.g., residential, commercial, school, business, etc.) to suppress a fire in the event a fire occurs. The fire suppression system 100 can direct a fire suppressant (e.g., water, agent, etc.) from a supply of fire suppressant to a specified area 12 in the building 10. The specified area 12 may be an area with a high occurrence of fires igniting (e.g., a kitchen, etc.) or may be any other area in the building 10. The fire suppression system 100 may activate (e.g., release the fire suppressant, etc.) in response to a signal from a user (e.g., a button, a pull box, etc.). The fire suppression system 100 may actuate in response to a signal from a detector (e.g., thermal detector, fusible link, smoke detector, etc.). The detector senses a condition (e.g., heat, CO₂ levels, etc.) and automatically actuates the fire suppression system 100 when the condition reaches a predetermined threshold.

The building 10 has a ceiling 14 which is angled at angle θ relative to a floor 16. Angle θ can be any angle (e.g., acute, obtuse, etc.). The fire suppression system 100 includes a pipe system, shown as piping 102. The piping 102 includes at least one pipe coupled with the ceiling 14. For example, the at least one pipe of the piping 102 can be connected with the ceiling

The piping 102 can be parallel to the ceiling 14 and at angle θ relative to the floor 16. The piping 102 includes the connectors 104 coupling each pipe and facilitating fluid communication between the pipes. The connectors 104 define a supply inlet 120 and the supply outlet 122. The supply inlet 120 and the supply outlet 122 facilitate flow of fire suppressant through the connectors 104 by receiving fire suppressant from an upstream pipe of the piping 102 and directing fire suppressant to a downstream pipe of the piping 102. Flow of fire suppressant from the supply inlet to the supply outlet define a flow path along a flow axis 106.

The connectors 104 also define an adapter outlet. The adapter outlet provides a second flow path out of the connector 104, allowing fluid to flow into adapter pipe 110. As depicted in FIG. 3, the second flow path can define a release axis 108, which can be perpendicular to the flow axis 106. The release axis 108 may be at an angle other than 90° relative to the flow axis 106. The angle between the release axis 108 and the flow axis 106 may be a required angle set forth by a governing agency (e.g., NFPA, etc.).

The fire suppression system 100 can include at least one adapter pipe 110. The adapter pipe 110 defines an inlet side 112 (e.g., inlet end) and an outlet side 114 (e.g., outlet end). Each the connector 104 couples to the inlet side 112 of the adapter pipe 110. The adapter pipe 110 may rotate relative to the flow axis 106. The adapter pipe 110 may be rotatably coupled with the connector 104. The adapter pipe 110 may be rotatable during installation of the fire suppression system 100 and fixedly coupled once installation has finished. The fire suppression system 100 also includes sprinklers 116. The sprinklers 116 are coupled with the outlet side 114 of the adapter pipe 110. The sprinklers 116 disperse fire suppressant flowing out of the adapter pipe 110 onto the specified area 12 during activation of the fire suppression system 100.

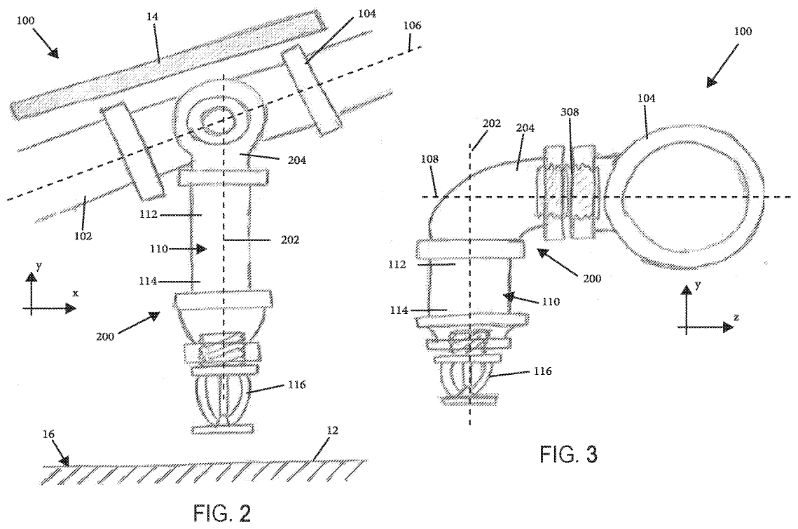

FIGS. 2 and 3 depict an adapter assembly 200 coupled with the piping 102. The adapter assembly 200 includes the adapter pipe 110, the connector 104, and sprinkler 116. The connector 104 is fixedly coupled with at least one pipe of the piping 102. The connector 104 also defines the flow axis 106, and the release axis 108. The release axis 108 can be parallel to the floor 16 in a z direction, enabling a spray pattern outputted by the sprinkler 116 to satisfy a target orientation. The flow axis 106 can be parallel to the ceiling 14 in an x-y direction. The adapter outlet of the connector 104 is positioned on a side of the piping 102. The outlet side 114 of the adapter pipe 110 is coupled with sprinkler 116. The adapter pipe 110 defines a target axis 202. The target axis 202 can be defined between the inlet side 112 and the outlet side 114. The target axis 202 can be in a y direction.

The adapter assembly 200 can include a redirection pipe 204. The redirection pipe 204 is coupled with the adapter outlet of the connector 104 and the inlet side 112 of the adapter pipe 110. The redirection pipe 204 can have an outlet at a different orientation than an inlet, such that an orientation of the sprinkler 116 when connected with the outlet is different than how the inlet connects with the adapter pipe 110. For example, redirection pipe 204 can be a curved pipe which interfaces with the release axis 108 and the target axis 202. Flow of fire suppressant through the redirection pipe 204 changes direction of flow along the release axis 108 to the target axis 202. The redirection pipe 204 can include an attachment member on a redirection pipe inlet side. The attachment member may be a thread which interfaces with a threading on one of the connector 104 and a threaded member 208. The threaded member 208 may rotatably couple with both the connector 104 and the redirection pipe 204. For example, during installation of the adapter assembly 200, the redirection pipe 204 may be rotatably coupled with the connector 104 with the threaded member 208. The redirection pipe 204 can be rotated to an orientation such that the target axis 202 is perpendicular to the floor 16. The threaded member 208 may include adhesive (e.g., thread glue, etc.) to fixedly couple the redirection pipe 204 and the connector 104. Fixedly coupling the redirection pipe 204 and the connector 104 can limit rotation of the redirection pipe 204 relative to the connector 104 and maintain the target axis 202 in a y direction. The redirection pipe 204 and the connector 104 may be bonded (e.g., adhesive, solder, etc.).

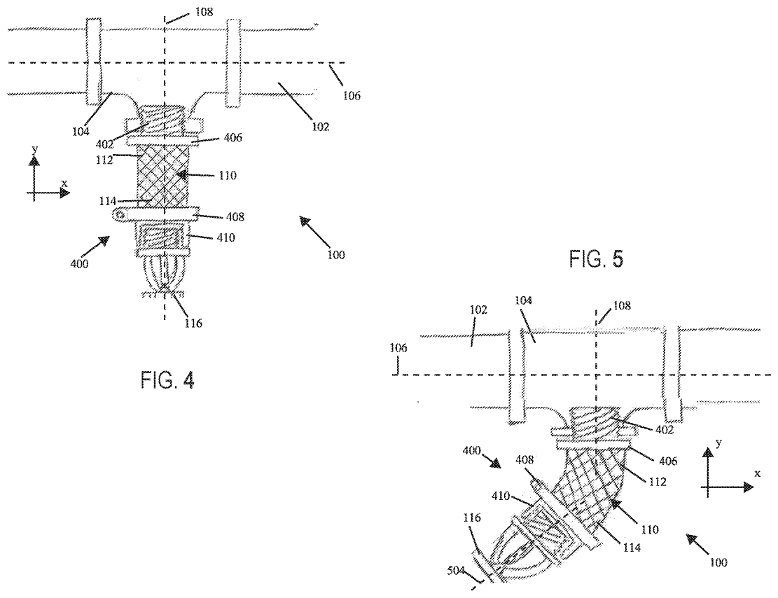

FIGS. 4 and 5 depict an adapter assembly 400 coupled with the piping 102. The adapter assembly 400 includes the connector 104, sprinkler 116, and the adapter pipe 110. The connector 104 defines the flow axis 106 and the release axis 108. The release axis 108 is in a y direction. The flow axis 106 is in an x-y direction. The inlet side 112 of the adapter pipe 110 is coupled with the adapter outlet of the connector 104. The inlet side 112 of the adapter pipe 110 includes a threading 402. The threading 402 rotatably couples to a corresponding threading in the adapter outlet of the connector 104. The outlet side 114 of the adapter pipe 110 defines a target axis 504. Release of fire suppressant occurs along the target axis 504. Sprinkler 116 is rotatably coupled with the outlet side 114 of the adapter pipe 110.

The adapter pipe 110 includes an inlet flange 406. The inlet flange 406 is located closer to the outlet side 114 than the threading 402. The inlet flange 406 may limit rotating of the adapter pipe 110 into the connector 104 to reduce over rotating. The adapter pipe 110 also includes an outlet flange 408. The outlet flange 408 may couple with a receiving thread 410 to the adapter pipe 110. The receiving thread 410 rotatably couples with the sprinkler 116. The outlet flange 408 may facilitates coupling between the adapter pipe 110 and the receiving thread 410. The outlet flange 408 may be formed as a monolithic structure with the adapter pipe 110 and the receiving thread 410.

The adapter pipe 110 may be made of a flexible material (e.g., rubber, etc.). The adapter pipe 110 may define a curve along which flow of fire suppressant can flow. Fire suppressant flow enters the adapter pipe 110 along the release axis 108 and transitions to the target axis 504 along the length of the adapter pipe 110. The adapter pipe 110 may include an elbow. The elbow is rotatable and defines a redirection section, changing flow of fluid from the release axis 108 to the target axis 504.

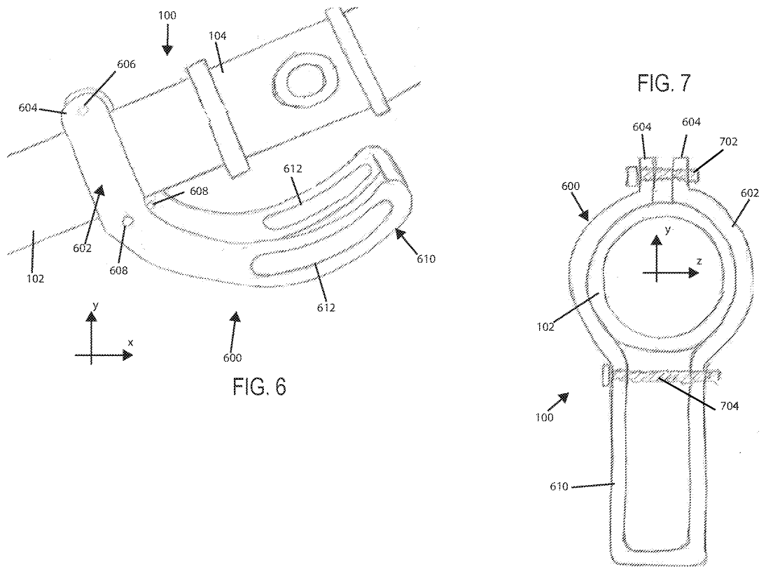

FIGS. 6 and 7 depict a locking mechanism 600 for use with the adapter assemblies 200, 400. The locking mechanism 600 may be coupled with either the piping 102 and/or the connector 104. The locking mechanism 600 is depicted to be coupled with the adapter pipe 110. The outlet side 114 of the release axis 108 can be held at a specific orientation (e.g., angle θ, etc.) relative to the release axis 108 by the locking mechanism 600. The locking mechanism 600 may be formed as a monolithic structure with the adapter pipe 110. The locking mechanism 600 may be coupled with the adapter pipe 110 and either the piping 102 and/or the connector 104 during installation of the fire suppression system 100.

The locking mechanism 600 can engage an outer surface of the piping 102. For example the locking mechanism 600 can include a member 602 that couples with the outer surface. The member 602 can be at least partially annular (e.g., semi-annular), allowing the member 602 to be fit around the piping 102. The member 602 can include at least one fastener flange 604, which can extend around the outer surface of the piping 102 (e.g., outward from the piping 102).

The fastener flanges 604 define at least one flange aperture 606. The flange apertures 606 can receive a fastener 702. The fastener 702 can be received through the flange apertures 606 to secure the fastener flanges 604 to the piping 102.

The member 602 can define at least one fastener aperture 608. The fastener apertures 608 can be defined opposite of the fastener flanges 604 relative to the outer surface of the piping 102. The fastener apertures 608 receive a fastener 704. The locking mechanism 600 selectively couples to the piping 102 by coupling the member 602 to the outer surface of the piping 102 and inserting fasteners 702, 704 in the flange apertures 606 and the fastener apertures 608, which can form a pressure fit on the piping 102.

The locking mechanism 600 can include a body 610. The body 610 can have a U-shape, enabling the body 610 to limit movement of a sprinkler or other piping components received in the body 610. The body 610 extends from member 602. The body 610 can define a pair of slots 612. The slots 612 can be defined along a length of the body 610. The slots 612 can receive a portion of an adapter assembly (e.g., adapter assembly 200, adapter assembly 400). The adapter pipe 110 may be positioned to be external to the locking mechanism 600. The adapter pipe 110 may include a fastener for coupling to the slots 612. Once coupled with the slots 612, the adapter pipe 110 can be locked and unable to rotate relative to the piping 102. Therefore, the target axis can be fixed relative to the release axis 108.

With respect to the adapter assembly 400, the slots 612 may receive a portion of the adapter assembly 400 such that the adapter pipe 110 may be between the slots 612 of the body 610. The outlet flange 308 may include a fastener that is received by the slots 612 and locks the outlet side 114 relative to the inlet side 112. Therefore, the target axis can be fixed relative to the release axis 108.

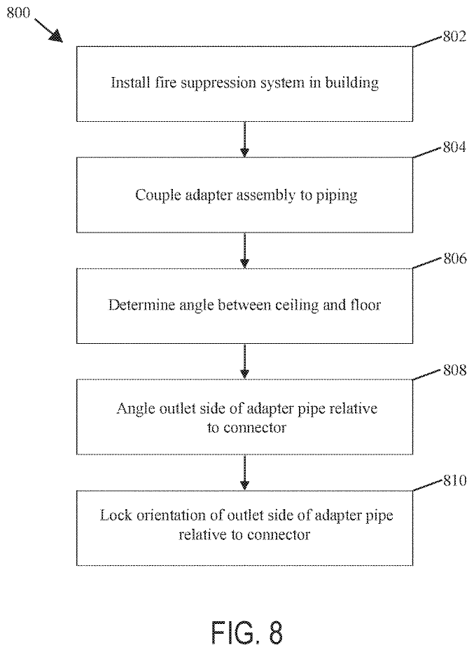

FIG. 8 depicts a method 800 for installing the fire suppression system 100 within the building 10. The method 800 can be performed in any order of the following steps. The method 800 can include further steps not described in the following steps. The method 800 can omit any steps included in the following steps. The method 800 can be performed using various systems and devices described herein, such as the fire suppression system 100, the adapter assemblies 200, 400, and the locking mechanism 600.

At 802, a fire suppression system is installed in a (e.g., building 10). A source of fire suppressant, such as a fluid source, is installed within the building 10. The source of fire suppressant may be remote from a specified area in the building, or may be in proximity to a specified area in the building (e.g., an area to be protected using the fire suppression system). Piping can be coupled with the source of fire suppressant. The piping can be coupled with a ceiling of the building. The ceiling and the piping can be parallel along a length of the specified area.

At 804, at least one adapter assembly (e.g., the adapter assembly 200, the adapter assembly 400) is coupled with the piping. The adapter assembly can include connectors that are coupled with the piping. The connectors may be spaced apart a predetermined distance. The predetermined distance may be set forth by the governing agency. The predetermined distance may also be calculated to cover a maximum area within the specified area. An inlet side of the adapter pipe can be coupled with an adapter outlet of the connector. For example, the inlet side can be coupled with the adapter outlet subsequent to connecting the connector with the piping. A sprinkler can be coupled with an outlet side of the adapter pipe. For example, the sprinkler can be coupled with the outlet side subsequent to connecting the adapter pipe with the connector. The sprinkler can align with a target axis (e.g., the target axis 202, the target axis 304).

At 806, an angle of the ceiling relative to a floor is determined. Determination of the angle can be facilitated by, for example, determining a height of the ceiling by measuring the vertical distance from the floor to a point on the ceiling furthest from ground, determining a horizontal distance between a point on the floor at which the vertical distance was measured and a particular wall at which the ceiling and a top portion of the wall connect, and determining a height of the wall. A height differential between the vertical distance and the height of the wall can be determined by subtracting the height of the wall from the vertical distance. The angle of the ceiling relative to the floor can be determined by determining an inverse tangent of the height differential divided by the horizontal distance. The angle of the ceiling relative to the floor can be determined between a plane in which the ceiling lies and a plane in which the floor lies (e.g., an angle formed at an intersection of the planes).

At 808, the outlet side of the adapter pipe can be angled relative to the connector. Thus, the target axis defined by the adapter pipe and the sprinkler can be angled relative to the release axis. Angling the outlet side of the adapter pipe relative to the connector facilitates changing a spray pattern and/or a spray area of the sprinkler. Changing the spray pattern and/or the spray area may increase the effectiveness of sprinkler at suppressing fire within the specified area. For example, the adapter pipe can be angled relative to the connector so that the spray pattern satisfies a spray pattern condition indicating expected water flow to particular locations on the floor.

At 810, an orientation of the adapter pipe can be fixed relative to the connector. For example, a locking mechanism may be used to lock the adapter pipe to the connector to fix the orientation of the adapter pipe relative to the connector, which can maintain the sprinkler at a target orientation for achieving the spray pattern. Fasteners can couple to a portion of the adapter pipe and to the locking mechanism to fix the adapter pipe to the connector. The locking mechanism can connect to an outer surface of the piping. Movement of the adapter pipe can be restricted relative to the piping and the connector by the locking mechanism.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act, or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. Further relative parallel, perpendicular, vertical, or other positioning or orientation descriptions include variations within +/−10% or +/−10 degrees of pure vertical, parallel, or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes, and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

What is claimed is:

1. A fire suppression system, comprising:
a pipe system in fluid communication with a fluid supply, the pipe system comprising a first pipe and a second pipe, the first pipe and the second pipe defining a fluid supply axis through the first pipe and the second pipe, the fluid supply axis oriented at an angle relative to a floor below the first pipe and the second pipe;
a connector comprising a connector inlet engaged with the first pipe, a connector outlet engaged with the second pipe, and an adapter outlet in communication with the connector inlet and the connector outlet;
at least one adapter pipe engaged with the adapter outlet of the connector; and
a sprinkler coupled with the at least one adapter pipe such that a spray pattern of fluid outputted by the sprinkler is oriented to correspond with a target orientation of the spray pattern.

2. The fire suppression system of claim 1, comprising:
the adapter outlet of the connector defines a fluid release axis; and
the at least one adapter pipe defines a target axis angled relative to the fluid release axis so that the sprinkler is oriented to correspond with the target orientation of the spray pattern.

3. The fire suppression system of claim 1, comprising:
the adapter outlet of the connector defines a fluid release axis;
the at least one adapter pipe defines a target axis angled relative to the fluid release axis; and
the at least one adapter pipe is oriented to angle the target axis at a target angle relative to at least one of the fluid release axis and the fluid supply axis so that the sprinkler is oriented to correspond with the target orientation of the spray pattern.

4. The fire suppression system of claim 1, comprising:
the at least one adapter pipe orients the sprinkler so that fluid flows through the sprinkler in a direction perpendicular to the floor.

5. The fire suppression system of claim 1, comprising:
an elbow coupled with the connector and the at least one adapter pipe, the elbow changes a direction of flow of fluid through the elbow relative to a fluid release axis defined by the connector.

6. The fire suppression system of claim 1, comprising:
a locking mechanism coupled with the at least one adapter pipe and at least one of the connector and the pipe system, the locking mechanism restricts movement of the at least one adapter pipe relative to the pipe system.

7. The fire suppression system of claim 1, comprising:
a locking mechanism coupled with the at least one adapter pipe, the connector, and the pipe system, the locking mechanism restricts movement of the at least one adapter pipe relative to the pipe system to maintain the sprinkler to be oriented to correspond with the target orientation of the spray pattern.

8. The fire suppression system of claim 1, comprising:
the at least one adapter pipe comprises a flexible pipe to allow an outlet end of the flexible pipe to move relative to an inlet end of the flexible pipe.

9. The fire suppression system of claim 1, comprising:
a locking mechanism coupled with the at least one adapter pipe and at least one of the connector and the pipe system, the locking mechanism includes a body that defines at least one slot that receives the at least one adapter pipe and at least one fastener flange that extends from the body and extends at least partially around the first pipe.

10. An adapter assembly, comprising:
a connector comprising a connector inlet that engages with a first pipe, a connector outlet that engages with a second pipe, and an adapter outlet in communication with the connector inlet and the connector outlet, the connector inlet and the connector outlet define a fluid supply axis;
at least one adapter pipe that engages with the connector outlet and defines a fluid release axis, the fluid release axis is at least one of acutely and obtusely angled relative to the fluid supply axis; and
a sprinkler coupled with the at least one adapter pipe such that a spray pattern of fluid outputted by the sprinkler is oriented to correspond with a target orientation of the spray pattern.

11. The adapter assembly of claim 10, comprising:
the at least one adapter pipe defines a target axis angled relative to the fluid release axis so that the sprinkler is oriented to correspond with the target orientation of the spray pattern.

12. The adapter assembly of claim 10, comprising:
the at least one adapter pipe defines a target axis angled relative to the fluid release axis; and
the at least one adapter pipe is oriented to angle the target axis at a target angle relative to at least one of the fluid release axis and the fluid supply axis so that the sprinkler is oriented to correspond with the target orientation of the spray pattern.

13. The adapter assembly of claim 10, comprising:
the at least one adapter pipe orients the sprinkler so that fluid flows through the sprinkler in a direction perpendicular to a floor.

14. The adapter assembly of claim 10, comprising:
an elbow coupled with the connector and the at least one adapter pipe, the elbow changes a direction of flow of fluid through the elbow relative to the fluid release axis.

15. The adapter assembly of claim 10, comprising:
a locking mechanism coupled with the at least one adapter pipe and at least one of the connector, the first pipe, and the second pipe, the locking mechanism restricts movement of the at least one adapter pipe relative to at least one of the first pipe and the second pipe.

16. The adapter assembly of claim 10, comprising:
a locking mechanism coupled with the at least one adapter pipe, the connector, and at least one of the first pipe and the second pipe, the locking mechanism restricts movement of the at least one adapter pipe relative to at least one of the first pipe and the second pipe to maintain the sprinkler to be oriented to correspond with the target orientation of the spray pattern.

17. The adapter assembly of claim 10, comprising:
the at least one adapter pipe comprises a flexible pipe to allow an outlet end of the flexible pipe to move relative to an inlet end of the flexible pipe.

18. The adapter assembly of claim 10, comprising:
a locking mechanism coupled with the at least one adapter pipe and at least one of the connector, the first pipe, and the second pipe, the locking mechanism includes a body that defines at least one slot that receives the at least one adapter pipe and at least one fastener flange that extends from the body and extends at least partially around the first pipe.

19. A method, comprising:
coupling at least one connector to a first pipe and a second pipe of a network of piping coupled with a ceiling of a building, the first pipe and second pipe defining a fluid supply axis;
attaching an adapter pipe to the at least one connector, the adapter pipe defines a fluid release axis;
attaching a sprinkler to the adapter pipe along the fluid release axis; and
angling the adapter pipe relative to the at least one connector such that the fluid release axis is at a target angle relative to a floor of the building and locking the adapter pipe such that the sprinkler is maintained in an orientation corresponding to a target orientation of a spray pattern of fluid outputted by the sprinkler.

20. The method of claim 19, comprising:
coupling a locking mechanism to the at least one adapter pipe and the first pipe to maintain the sprinkler to be oriented to correspond to the target orientation of the spray pattern.
